(19) United States
(12) Patent Application Publication
(10) Pub. No.: US 2013/0048547 A1
(43) Pub. Date: Feb. 28, 2013

(54) FILTRATION SYSTEM FOR AIR CONDITIONER UNIT COOLANT

(71) Applicants: Larry McKenna, Huntington Beach, CA (US); David Tye, Huntington Beach, CA (US)

(72) Inventors: Larry McKenna, Huntington Beach, CA (US); David Tye, Huntington Beach, CA (US)

(21) Appl. No.: 13/221,762

(22) Filed: Aug. 30, 2011

(51) Int. Cl. B01D 29/56

(52) U.S. Cl. 210/167.3; 210/202

(57) ABSTRACT

Provided is a filtration system for filtering contaminants and impurities from a coolant, such as water, applied to an air conditioner unit for cooling the air conditioning unit to increase the efficiency thereof. The filtration system filters the coolant to achieve a desired purity level to allow the coolant to mitigate corrosion or particle buildup on the air conditioning unit when the coolant is applied thereto. Along these lines, if the purity level is too low, the contaminants present in the coolant may corrode the air conditioning unit. Conversely, if the purity level is too high, the coolant itself may react with the air conditioning unit, which may lead to corrosion or other structural issues. Thus, the filtration system is specifically configured and adapted to purify the coolant to achieve a purity level within a desirable purity range.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates generally to a filtration system, and more specifically, to a filtration system for a coolant applied to an air conditioner unit for cooling the air conditioner unit to increase the efficiency thereof.

2. Description of the Related Art

Air conditioner condenser units have evolved since early units which generally discharged air flow in a generally horizontal direction, i.e., substantially parallel to the ground or base. More modern condensers typically include a side air inlet and a vertical air discharge. In order to improve the efficiency of the units, systems have been developed which spray a mist of cool water on or around external condenser units of air conditioners to cool the units in order to improve their efficiency.

One early system included a water reservoir placed below the condenser coils such that water was drawn from the reservoir and pumped upward to be sprayed onto the condenser. The water trickled down along the condenser and returned to the reservoir. water may accumulate below the condenser, which generally results in mosquitoes and algae.

Other systems employ a paddle switch or paddle valve that is activated by airflow created when the fan for the condenser is running. For instance, the system may include a horizontal air flow condenser with an airflow-operated paddle valve assembly conventionally fixed to the air conditioner housing in the path of the horizontally-exhausted air stream. The paddle pivots on a horizontal pin under the force of horizontal air from the unit fan, thereby overcoming a spring pressure exerted on the paddle to keep the valve normally-closed.

The systems described above illustrate the importance of delivering a coolant to the air conditioner unit to cool the air conditioner unit for increasing the efficiency thereof. However, a common problem associated with applying a coolant to the air conditioning unit is that when the coolant is applied to the housing of the air conditioner unit, the coolant may lead to corrosion or other structural issues. More specifically, the contaminants and solids present in the coolant have a tendency to chemically react with the air conditioner housing to cause the corrosion or the like. One alternative is to remove the contaminants and particles from the coolant before the coolant is sprayed onto the air conditioning unit. However, if the coolant is too pure, the coolant itself may react with the air conditioning housing to cause the corrosion, etc.

Accordingly, there is a need in the art for a filtration system which may be easily connected to a coolant source for filtering the coolant to achieve a purity level which mitigates corrosion on an air conditioning unit when the coolant is applied thereto. The present invention addresses this particular need, as will be discussed in more detail below.

### BRIEF SUMMARY OF THE INVENTION

According to an aspect of the present invention, there is provided a filtration system for filtering contaminants and impurities from a coolant, such as water, applied to an air conditioner unit for cooling the air conditioning unit to increase the efficiency thereof. The filtration system filters the coolant to achieve a desired purity level mitigates corrosion or particle buildup on the air conditioning unit when the coolant is applied thereto. Along these lines, if the purity level is too low, the contaminants present in the coolant may corrode the air conditioning unit. Conversely, if the purity level is too high, the coolant itself may react with the air conditioning unit, which may lead to corrosion or other structural issues. Thus, the filtration system is specifically configured and adapted to purify the coolant to achieve a purity level within a desirable purity range.

According to one embodiment, the filtrations system includes a pre-treatment assembly fluidly connectable to a coolant source to receive coolant therefrom. The pre-treatment assembly includes a carbon filter configured to remove contaminants from the coolant as the coolant passes through the carbon filter. The pre-treatment assembly further includes a polymer addition unit in fluid communication with the carbon filter and configured to add polymer to the coolant as the coolant passes therethrough. The pre-treatment assembly additionally includes a sediment filter in fluid communication with the polymer addition unit and configured to remove sediments larger than 5 micrometers from the coolant as the coolant passes therethrough. The filtration system further includes a nanofiltration unit in fluid communication with the pre-treatment assembly to receive the coolant therefrom and to provide nanofiltration to the coolant as the coolant passes therethrough. A distribution unit is in fluid communication with the nanofiltration unit to receive coolant therefrom and to distribute the coolant to the air conditioning unit.

The filtration system may include a pump for circulating the coolant through the system. The pump may be disposed between the pre-treatment assembly and the nanofiltration unit. The pump may operate at a pressure less than 250 psi, and preferably around 100 psi.

The nanofiltration unit may include several nanofiltration members including nanofiltration membranes. The nanofiltration members may be manifolded together at the input and the output.

The distribution unit may include several distribution pumps to deliver the filtered coolant to one or more air conditioner units. According to one implementation, each distribution pump may be capable of delivering coolant to thirty (30) air conditioning units.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a schematic view of a filtration system for a coolant for an air conditioning unit;

FIG. 2 is an upper perspective view of one embodiment of the filtration system;

FIG. 3 is a front elevation view of the filtration system depicted in FIG. 1, the front panel of the control box being partially cutaway to illustrate the inside of the control box; and

FIG. 4 is a rear elevation view of the filtration system.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, where the showings are for illustrating a preferred embodiment of the present invention only, and not for purposes of limiting the same, there is shown a filtration system 10 for filtering water, or another coolant, which may be applied to the housing of an air conditioner to increase the efficiency of the air conditioner. For instance, the water may be sprayed on the air conditioner to keep the air conditioner cool during operation, thereby increasing the operating efficiency of the air conditioner. The filtration system 10 is configured to filter the coolant to remove contaminants and impurities which may cause the metal on the air conditioner to corrode if the contaminants and impurities are not removed from the coolant. However, the filtration system 10 may be configured to allow some of the particles within the coolant to remain to prevent the coolant from reacting with the air conditioner housing.

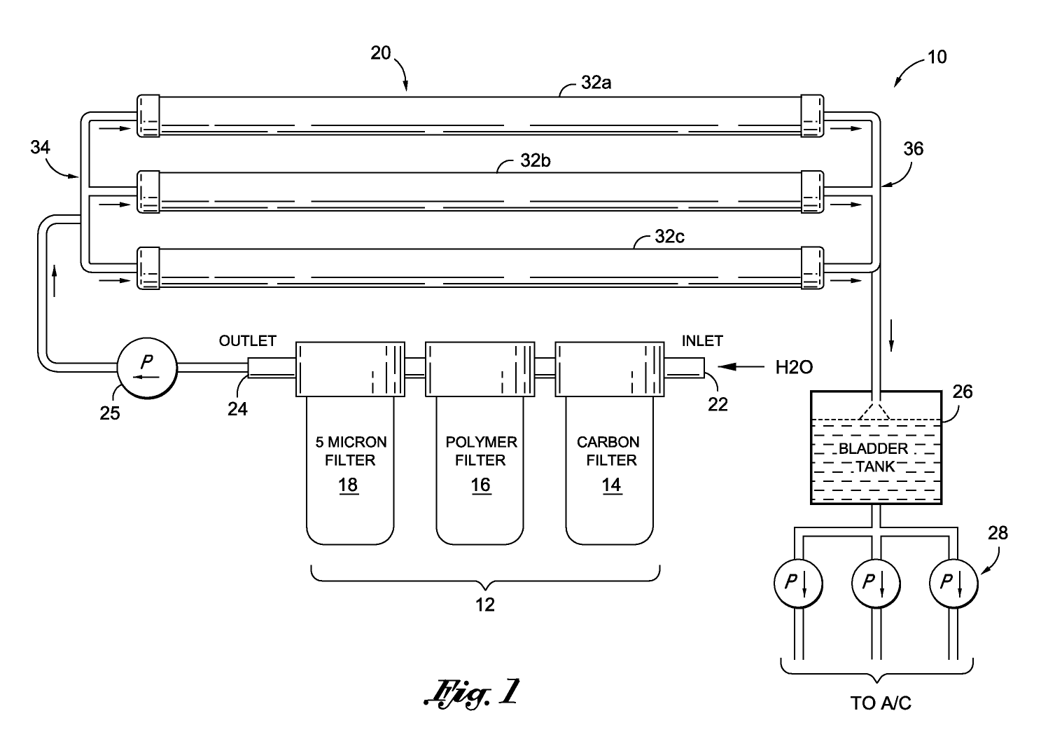

Referring now specifically to FIG. 1, there is shown a schematic diagram of the filtration system 10 to generally illustrate the primary components of the filtration system 10, as well as the general flow path of the water through the filtration system 10. The filtration system 10 includes a pre-treatment assembly 12 comprised of a carbon filter 14, a polymer addition device 16, and a five micron filter 18. The system 10 further includes a pump 25, a nanofiltration unit 20, a holding tank 26, and a distribution unit 28.

The pre-treatment assembly 12 receives water from a water source, such as a municipal water supply, at the inlet 22. The water flows through the pre-treatment assembly 12, i.e., through the carbon filter 14, polymer addition device 16, and the five micron filter 18, and exits the pre-treatment assembly 12 through an outlet 24. According to one embodiment, the pump 25 is disposed intermediate the pre-treatment assembly 12 and the nanofiltration unit 20 to pump water through the system from the inlet 22 to the holding tank 26. In this regard, the pump 25 may be configured to draw the water through the pre-treatment assembly 12 and to deliver the water to the nanofiltration unit 20. The pump 25 may further be configured to generate enough pressure to drive the water through the nanofiltration unit 20. After the water passes through the nanofiltration unit 20, the water enters the temporary holding tank 26 before being distributed by a distribution unit 28. The pre-treatment assembly 12, pump 25, nanofiltration unit 20, holding tank 26, and distribution unit 28 may be fluidly connected to each other via conduits, tubing, pipes, valves or other plumbing fixtures known by those skilled in the art.

The general architecture of the filtration system 10 is configured to provide a pre-treatment assembly 12 including a first stage filter, a polymer addition device 16, and a second stage filter. According to one embodiment, the first-stage filter is a carbon filter 14 and the second stage filter is a five micron filter 18, although other filters or filtering devices known by those skilled in the art may also be used. As shown in FIG. 1, the water flows from the carbon filter 14 to the polymer addition device 16 and then to the five micron filter 18. However, those skilled in the art will appreciate that the above-described configuration is exemplary in nature only and is not intended to limit the scope of the present invention. In this regard, the placement or arrangement of the carbon filter 14, polymer addition device 16 and the five micron filter 18 may be modified without departing from the spirit and scope of the present invention.

According to one embodiment, the carbon filter 14 is configured to filter or remove contaminants and impurities from the water utilizing chemical adsorption. As such, the carbon filter 14 may be effective at removing chlorine, sediment and other volatile organic compounds from the water. After extensive usage of the carbon filter 14, the effectiveness thereof may begin to diminish, and thus, the carbon filter 14 may be replaced to maintain effective operation of the filtration system 10.

The polymer addition device 16 is positioned downstream of the carbon filter 14 and receives the water from the carbon filter 14. Thus, in the exemplary embodiment, the water has undergone a first stage of filtration prior to passing through the polymer addition device 16. As water flows through the polymer addition device 16, a polymer is added to the water to treat the water for subsequent passage of the water through the nanofiltration device 20. In this regard, the polymer addition device 16 may allow the filtration device 10 to achieve a desired flow rate through the entire system 10. In other words, the water may flow more freely through the nanofiltration unit 20 as a result of the polymer added to the water by the polymer addition device 16.

The five micron filter 18 is positioned downstream of the polymer addition device 16 and receives the water from the polymer addition device 16. The five micron filter 18 is configured to remove particles from the water as the water passes through the five micron filter 18. According to one embodiment, the filter 18 is configured to remove particles defining a size greater than or equal to five microns, although other filters which may be configured to remove particles less than five microns or great than five microns may be used without departing from the spirit and scope of the present invention.

Turning now to the nanofiltration unit 20, a series of membranes are employed by the nanofiltration unit 20 for removing contaminants from the water. In the schematic shown in FIG. 1, the nanofiltration unit 20 includes three nanofiltration members 32a, 32b, 32c through which the water passes to achieve nanofiltration. The nanofiltration members 32a, 32b, 32c are manifolded together at a nanofiltration inlet 34 and a nanofiltration outlet 36. Thus, the water received from the pre-treatment assembly 12 is divided at the nanofiltration inlet 34 to pass through the nanofiltration members 32a, 32b, 32c in parallel. The nanofiltered water is then combined at the nanofiltration outlet 36.

Although the nanofiltration unit 20 shows a series of nanofiltration members 32a, 32b, 32c disposed in parallel to each other, it is contemplated that other embodiments of the nanofiltration unit 20 may include nanofiltration members 32a, 32b, 32c arranged in series, i.e., the water would flow from member 32a, then through member 32b, and finally through member 32c. Furthermore, the nanofiltration unit 20 includes three nanofiltration members 32a, 32b, 32c; however, nanofiltration units 20 having fewer than three members (i.e., including a single member), or more than three members may also be used.

According to one embodiment, the filtration system 10 is configured to remove most, but not all, of the contaminants from the water. In this regard, the contaminants present within the water may cause corrosion and buildup on the air conditioner if the water is not purified/filtered before being sprayed onto the air conditioner. However, if the water is too pure, the water may react with the metal of the air conditioner which could also lead to corrosion. As such, the filtration system 10 preferably removes approximately 90% of the contaminants and leaves the remaining 10% (i.e., 90% pure). However, other embodiments may filter the water within a range of 80%-95%.

With the filtering devices discussed above, reference is now made to the pump 25, which is operative to control the flow of water through the system 10. The pump 25 preferably operates at approximately 100 psi, which is significantly less than pressure required for a conventional reverse osmosis system, which typically operates at approximately 250 psi. Due to system's operability at reduced pressure, a smaller pump may be used to pump water through the system 10, which may require less energy and result in reduced operating expenses. As such, the system 10 may be environmentally friendly filtering system.

After the water is pumped through the various filtration devices, the water is temporarily stored in a holding tank 26 for subsequently distribution to the air conditioning unit(s). According to one embodiment, the holding tank 26 may be a bladder tank, which may expand and contract in connection with the ebb and flow of water through the tank 26. The tank 26 allows filtered water to be stored for immediate dispensing when needed by the air condition, i.e., when the air conditioner is turned ON.

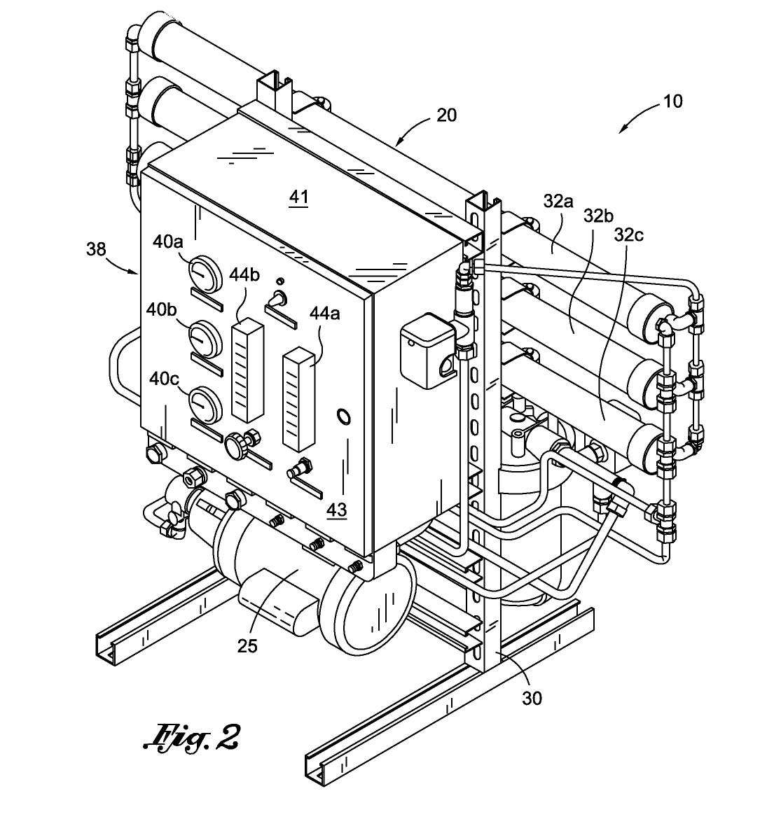

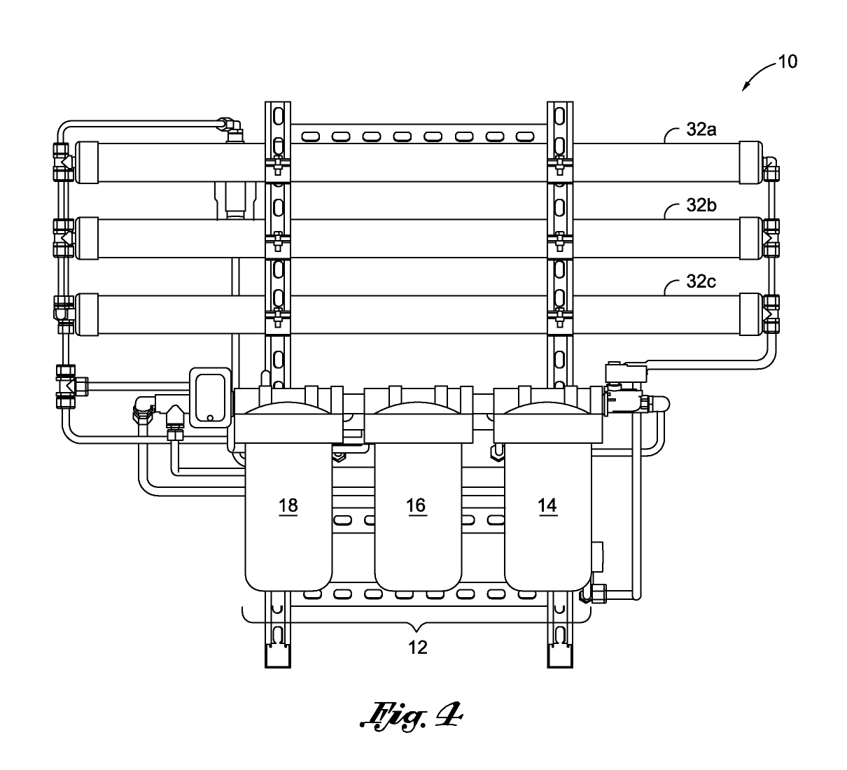

Referring now to FIG. 2-4 there is shown an embodiment of the filtration system 10. The filtration system 10 includes a support bracket 30 which the pre-treatment assembly 12, pump 25, and nanofiltration unit 20 may be mounted to. As shown, the pre-treatment assembly 12 and the nanofiltration unit 20 are connected to one side of the support bracket 30, while the pump 25 and a control unit 38 are connected to the opposing side of the support bracket 30. The particular mounting configuration shown in the Figures allows for a compact design, although those skilled in the art will appreciate that the mounting configuration is exemplary in nature only and is not intended to limit the scope of the present invention.

The control unit 38 functions to monitor and control operation of the system 10. The exemplary control unit 38 includes a control housing 40 having a plurality of side walls 41, a front panel 43, and a rear panel 45 connected to the side walls 41. The control unit 38 further includes a plurality of pressure gauges 42a-c and flow meters 44a-b for monitoring the fluid pressure at various locations within the system 10 as well as the flow rate through the system 10. For instance, pressure gauge 40a may monitor the pressure from the inlet feed (i.e., the pressure from the municipal water supply), pressure gauge 40b may monitor the pressure from the main pump 25 to the nanofiltration unit 20, and pressure gauge 40c may monitor the pressure of the water leaving the nanofiltration unit 20. The pressure gauges 40a-c allow an operator to quickly view the operating pressures at various locations throughout the system. Furthermore, each pressures gauge 40a-40c may be associated with a corresponding pressure sensor to measure the local fluid pressure.

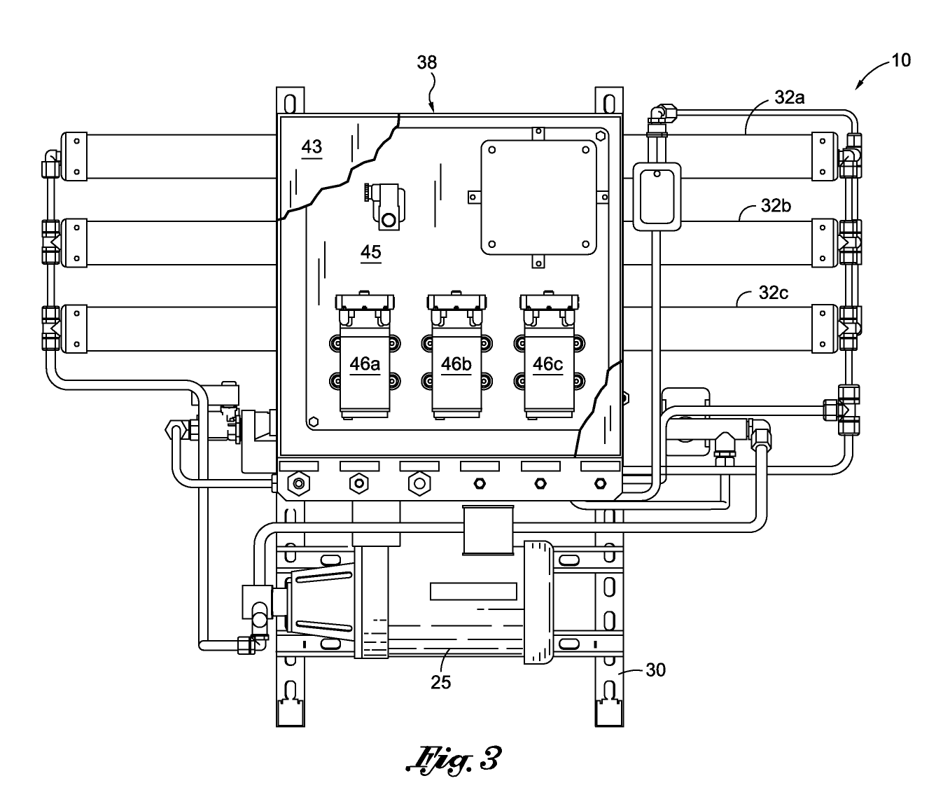

Referring now specifically to FIG. 3, a portion of the front panel 43 has been cut away to reveal the inside of the control unit 38, wherein several distribution pumps 46a-c are located. The distribution pumps 46a-c are part of the distribution unit 20, and the pumps 46a-c receive filtered water from the nanofiltration unit 20 and distribute the filtered water to the air conditioner(s). It is contemplated that each pump 46a-c may pump water through a distribution network configured to deliver water to several air conditioning units. For instance, each pump 46a-c may be configured to deliver water to thirty (30) air conditioners. Thus, in the embodiment shown in FIG. 3, the three distribution pumps 46a-c may provide water to ninety (90) air conditioners. Those skilled in the art will appreciate that the foregoing is exemplary in nature only and is not intended to limit the scope of the present invention. Along these lines, pumps may be used which provide enough capacity to distribute filtered water to a single air conditioner, or conversely, stronger pumps may be used to distribute filtered water to more than thirty (30) air conditioners.

The system 10 may be in operative communication with the control system of the air conditioner(s) to coordinate operation of the system 10 in connection with operation of the air conditioner(s). For instance, the system 10 may be wired to the thermostat, such that when the thermostat senses a temperature which is set to initiate operation of the air conditioner(s), the filtration system 10 is also triggered. Thus, in a preferred embodiment, the filtration system 10 is ON when the air conditioner is ON, and conversely, the filtration system 10 is OFF when the air conditioner(s) is OFF. In this regard, the pump 25 and pumps 46a-c may be wired to the thermostat, such that the pump 25 and pumps 46a-c may receive an ON signal from the thermostat to initiate operation of the system 10. Furthermore, the system 10 may include one or more valves which may be in operative communication with the thermostat to open or close the valves for controlling the fluid flow through the system 10.

Although the embodiment described above and depicted in the Figures is an exemplary embodiment, those skilled in the art will understand that various components may be removed therefrom or added thereto without departing from the spirit and scope of the present invention. For instance, although a pre-treatment assembly 12 comprised of a carbon filter 14, polymer addition device 16 and five micron filter 18 is effective in removing a suitable amount of contaminants and preparing the water for passage through the nanofiltration unit 20, it is understood that one or more of the pre-treatment assembly elements 14, 16, 18 may be removed without departing from the spirit and scope of the present invention.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A filtration system for a coolant applied to an air conditioning unit, the filtration system being configured for use with a coolant source, the filtrations system comprising:
a pre-treatment assembly fluidly connectable to the coolant source to receive coolant therefrom, the pre-treatment assembly comprising:
a carbon filter configured to remove contaminants from the coolant as the coolant passes through the carbon filter;
a polymer addition unit in fluid communication with the carbon filter and configured to add polymer to the coolant as the coolant passes therethrough; and
a sediment filter in fluid communication with the polymer addition unit and configured to remove sediments larger than 5 micrometers from the coolant as the coolant passes therethrough;
a nanofiltration unit in fluid communication with the pre-treatment assembly to receive the coolant therefrom and to provide nanofiltration to the coolant as the coolant passes therethrough; and
a distribution unit in fluid communication with the nanofiltration unit to receive coolant therefrom and to distribute the coolant to the air conditioning unit.

2. The filtration system recited in claim 1, wherein the carbon filter is positioned upstream relative to the polymer addition unit.

3. The filtration system recited in claim 1, wherein the polymer addition unit is positioned upstream relative to the sediment filter.

4. The filtration system recited in claim 1, further comprising an intermediate pump in fluid communication with the pre-treatment assembly and the nanofiltration unit, the intermediate pump being configured to pump coolant from the pre-treatment assembly to the nanofiltration unit.

5. The filtration system recited in claim 4, wherein the pump is configured to operate at a pressure less than 200 psi.

6. The filtration system recited in claim 5, wherein the pump is configured to operate at a pressure less than 100 psi.

7. The filtration system recited in claim 1, wherein the nanofiltration unit includes an inlet manifold, an outlet manifold and a plurality of nanofiltration elements fluidly connected to the inlet manifold and the outlet manifold.

8. The filtration system recited in claim 1, wherein the distribution unit includes a bladder tank to temporarily store filtered coolant and a distribution pump configured to pump the filtered coolant from the bladder tank to the air conditioning unit.

9. A filtration system for a coolant applied to an air conditioning unit, the filtration system being configured for use with a coolant source, the filtrations system comprising:
a pre-treatment assembly fluidly connectable to the coolant source to receive coolant therefrom, the pre-treatment assembly comprising:
a filter configured to remove solids from the coolant as the coolant passes through the filter;
a polymer addition unit in fluid communication with the filter and configured to add polymer to the coolant as the coolant passes therethrough;
a nanofiltration unit in fluid communication with the pre-treatment assembly to receive the coolant therefrom and to provide nanofiltration to the coolant as the coolant passes therethrough.

10. The filtration system recited in claim 9, wherein the filter includes a carbon filter.

11. The filtration system recited in claim 9, wherein the filter includes a sediment filter configured to remove solids defining a size greater than 5 micrometers.

12. The filtration system recited in claim 9, wherein the filter includes a carbon filter and a sediment filter configured to remove solids defining a size greater than 5 micrometers, the carbon filter being upstream of the polymer addition unit and the sediment filter being downstream of the polymer addition unit.

13. The filtration system recited in claim 9, further comprising a distribution unit in fluid communication with the nanofiltratino unit to receive coolant therefrom and to distribute the coolant to the air conditioning unit.

14. The filtration system recited in claim 13, wherein the distribution unit includes a bladder tank to temporarily store filtered coolant and a distribution pump configured to pump the filtered coolant from the bladder tank to the air conditioning unit.

15. The filtration system recited in claim 9, further comprising an intermediate pump in fluid communication with the pre-treatment assembly and the nanofiltration unit, the intermediate pump being configured to pump coolant from the pre-treatment assembly to the nanofiltration unit.

16. The filtration system recited in claim 15, wherein the pump is configured to operate at a pressure less than 200 psi.

17. The filtration system recited in claim 16, wherein the pump is configured to operate at a pressure less than 100 psi.

18. The filtration system recited in claim 9, wherein the nanofiltration unit includes a plurality of nanofiltration elements.

19. The filtration system recited in claim 18, further comprising an inlet manifold and an outlet manifold in fluid communication with the plurality of nanofiltration elements.

20. A filtration system for filtering a fluid, the filtration system comprising:
a filter configured to remove contaminants from the fluid as the fluid passes through the filter;
a polymer addition unit in fluid communication with the filter and configured to add polymer to the fluid as the fluid passes therethrough;
a nanofiltration unit in fluid communication with at least one of the filter and the polymer addition unit to receive the fluid therefrom and to provide nanofiltration to the fluid as the coolant passes therethrough.
